(19) United States
(12) Patent Application Publication
(10) Pub. No.: US 2010/0162033 A1
(43) Pub. Date: Jun. 24, 2010

(54) ETHERNET APPARATUS CAPABLE OF LANE FAULT RECOVERY AND METHODS FOR TRANSMITTING AND RECEIVING DATA

(76) Inventors: Kye-hyun Ahn, Daejeon-si (KR); Je-soo Ko, Daejeon-si (KR)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/580,174

(22) Filed: Oct. 15, 2009

(30) Foreign Application Priority Data
Dec. 22, 2008 (KR) 10-2008-0131652

(51) Int. Cl. G06F 11/20

(52) U.S. Cl. 714/4; 714/E11.078

(57) ABSTRACT

An Ethernet apparatus for performing lane fault recovery is provided. An Ethernet apparatus capable of lane fault recovery includes a data transmitter using a backup lane in the transport link to transmit data intended to be transmitted via the faulty lane when at least one faulty lane is detected from the data transfer lanes, and a data receiver recognizing the data received via the backup lane as data transferred via the faulty lane when the faulty lane is detected. In an Ethernet apparatus having a multi-lane structure, a lane fault and faulty lanes can be accurately recognized while maintaining compatibility with a standard Ethernet apparatus.

### CROSS-REFERENCE TO RELATED APPLICATION

This application claims the benefit under 35 U.S.C. §119(a) of Korean Patent Application No. 10-2008-0131652, filed on Dec. 22, 2008, the disclosure of which is incorporated herein in its entirety by reference.

### BACKGROUND

1. Field

The following description relates to an Ethernet apparatus for high-speed broadband transmission, and more particularly, to an Ethernet apparatus for lane fault recovery.

2. Description of the Related Art

Under the influence of fusion of different types of communication environments and digital fusion, rapid growth of multimedia communication service has come to require a high-speed broadband transmission system. Accordingly, there is an increasing need for high-speed Ethernet transmission technology that supports a data rate of tens of gigabits or more.

The high-speed Ethernet transmission technology includes techniques employing a multi-lane structure. The multi-lane structure includes a group of several lanes having a lower transmission rate in order to establish a link having a high transmission rate, i.e., a single aggregated high-speed link.

For example, an Ethernet transmission system having a high data transmission rate can be built by processing data transmitted from a media access control (MAC) layer to a physical (PHY) layer at a transmission rate of 100 gigabits using ten lanes each having a transmission rate of 10 gigabits for 100 gigabit Ethernet.

With this structure, a high-speed transmission system can be implemented which can yield valuable effects using a plurality of inexpensive elements. However, such broadband transmission of tens of gigabits or more must have high reliability because of mass data transmission.

Standardized Ethernet technology uses a local fault (LF) message and a remote fault (RF) message to signal a link fault. The LF and RF messages are intended for recognizing only an Ethernet link fault, indicating the fault, and performing a protection switching function.

Conventional protection switching technology with high reliability includes a control to re-establish a path in a 1+1 and 1:N method or use a previously set backup path for Ethernet link fault recovery at a system or network level.

However, when this technology is applied to the Ethernet structure having a multi-lane, the fault of one lane is processed as a whole link fault, such that protection switching is performed on whole link traffic. That is, protection switching is performed on other traffic transferred via normal lanes, as well as via faulty lanes. This control method processes additional lanes unnecessarily, which increases a relatively recovery time and requires more resources for recovery.

A scheme for recovering a lane fault separately from a link fault in an Ethernet structure in which a single high-speed link consists of a plurality of lanes has been proposed. This scheme defines a local lane fault (LLF) message and a remote lane fault (RLF) message using unused fields, as in the LF message and the RF message, in order to signal a lane fault while maintaining compatibility with Ethernet technology. However, since this scheme only indicates a lane fault separately from a link fault, it is necessary to recognize which of a plurality of lanes is faulty to provide better lane fault recovery.

Accordingly, there is a scheme for transferring information indicating lane faults and faulty lanes for switching the faulty lanes.

A method for using forward error correction (FEC) per a packet block having a predetermined length transferred via lanes, for lane fault recovery, has been proposed. In this method, two additional data lanes, i.e., a protection lane and an FEC lane, are used. The protection lane is used to transfer a result of logically combining values transferred via data lanes, and the FEC lane is used to transfer data for FEC-processing a predetermined data block. A receiving side may detect a lane fault and correct a 1-bit fault by itself without requesting additional information.

This method enables faults to be detected and corrected using the FEC at a transmitting side and a receiving side. However, effects of fault detection and correction are limited to several bits because FEC processing technology is complex to implement and delay of the processing increases. Also, the method requires two additional lanes, including a lane for transferring overhead information for FEC processing.

Another method for recovering a lane fault includes a method for distributing and transferring traffic using available lanes excluding faulty lanes. When a faulty lane is detected, the traffic is transferred with a bandwidth that is reduced by flow control on an upper layer.

This fault recovery method requires no additional resource for fault recovery, but reduces a bandwidth, which affects traffic transferred via normal lanes. Accordingly, traffic is delayed.

It is necessary not to affect traffic transferred via normal lanes and control only faulty lanes for lane fault recovery. Also, since there are various causes of lane faults, fault control capacity at a level of several bits is insufficient. It is also necessary to minimize additional resources for protection switching.

### SUMMARY

The following description relates to an Ethernet apparatus for identifying a lane fault and faulty lanes separately from a link fault.

The following description also relates to an Ethernet apparatus for recovering traffic transferred via a single faulty lane without affecting other lanes.

In one general aspect, there is provided an Ethernet apparatus capable of lane fault recovery in which data is transmitted and received via a transport link including a plurality of data transfer lanes. The apparatus includes a data transmitter using a backup lane in the transport link to transmit, data intended to be transmitted via the faulty lane when at least one faulty lane is detected from the data transfer lanes and a data receiver recognizing the data received via the backup lane as data transferred via the faulty lane when the faulty lane is detected.

The data transmitter may include a backup-lane inserting unit, the backup-lane inserting unit including a data-lane output unit selecting data received via the plurality of transfer lanes or a backup block in response to a fault detection signal and outputting the selected data or backup block, and a backup-lane output unit selecting the backup block or the data intended to be transferred via the detected faulty lane in response to the fault detection signal and outputting the selected backup block or data via the backup lane.

The data receiver may include a backup-lane remover selecting data received via one of the plurality of transfer lanes or via the backup lane according to whether the lane is faulty, outputting the selected data, and removing the data received via the backup lane.

In another general aspect, there is provided a method for transmitting data via a transport link comprising a plurality of data transfer lanes. The method includes detecting at least one faulty one from the data transfer lanes and using a backup lane in the transport link to transfer data intended to be transmitted via the faulty lane.

The transferring of the data may include selecting data received via one of the plurality of transfer lanes or a backup block in response to a fault detection signal and outputting the selected data or backup block and selecting the backup block or the data intended to be transferred via the detected faulty lane in response to the fault detection signal and outputting the selected backup block or data via the backup lane.

In another general aspect, there is provided a method for receiving data via a transport link comprising a plurality of data transfer lanes. The method includes receiving data via the plurality of data transfer lanes and backup lanes and recognizing the data received via the backup lane as data transferred via a faulty lane of the plurality of data transfer lanes when the faulty lane is detected.

Other objects, features and advantages will be apparent from the following description, the drawings, and the claims.

### BRIEF DESCRIPTION OF THE DRAWINGS

FIG. 1 illustrates a 100 gigabit Ethernet transmission system according to an exemplary embodiment of the present invention;

FIG. 2 illustrates a lane fault message according to an exemplary embodiment of the present invention;

FIG. 3 illustrates an Ethernet lane fault recovery system according to an exemplary embodiment of the present invention;

FIG. 4 is a block diagram illustrating a transmitting Ethernet apparatus according to an exemplary embodiment of the present invention;

FIG. 5 is a block diagram illustrating a backup-lane inserting unit according to an exemplary embodiment of the present invention;

FIG. 6 is a block diagram illustrating a receiving Ethernet apparatus according to an exemplary embodiment of the present invention;

FIG. 7 is a block diagram illustrating a backup-lane remover according to an exemplary embodiment of the present invention;

FIG. 8 is a flowchart illustrating a method for transmitting data according to an exemplary embodiment of the present invention; and

FIG. 9 is a flowchart illustrating a method for receiving data according to an exemplary embodiment of the present invention.

Elements, features, and structures are denoted by the same reference numerals throughout the drawings and the detailed description, and the size and proportions of some elements may be exaggerated in the drawings for clarity and convenience.

### DETAILED DESCRIPTION OF EMBODIMENTS

The detailed description is provided to assist the reader in gaining a comprehensive understanding of the methods, apparatuses and/or systems described herein. Various changes, modifications, and equivalents of the systems, apparatuses, and/or methods described herein will likely suggest themselves to those of ordinary skill in the art. Also, descriptions of well-known functions and constructions are omitted to increase clarity and conciseness.

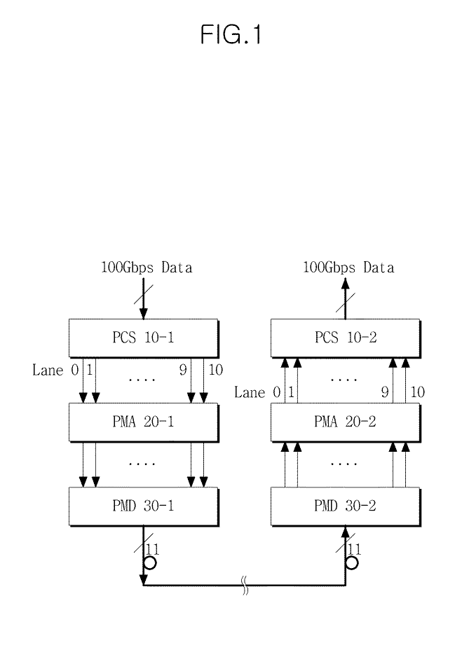

FIG. 1 illustrates a 100 gigabit Ethernet transmission system according to an exemplary embodiment of the present invention.

A physical (PHY) sublayer of a 100 gigabit Ethernet apparatus having a multi-lane structure in which eleven lanes having 10 gigabit transmission capacity are included from a transmitting stage to a receiving stage is shown in the present exemplary embodiment. The eleven lanes include ten data lanes and one backup lane.

The PHY layer includes three sublayers including a physical coding sublayer (PCS), a physical medium attachment (PMA), and a physical medium dependent (PMD). The PCS encodes/decodes bit string data received from the MAC layer and transfers the resultant data to the PMA. The PMA converts parallel data received from the PCS into serial data, and recovers a clock from a signal received from the PMD. The PMD performs conversion between an optical signal and an electrical signal and includes modem technology for faultless transmission.

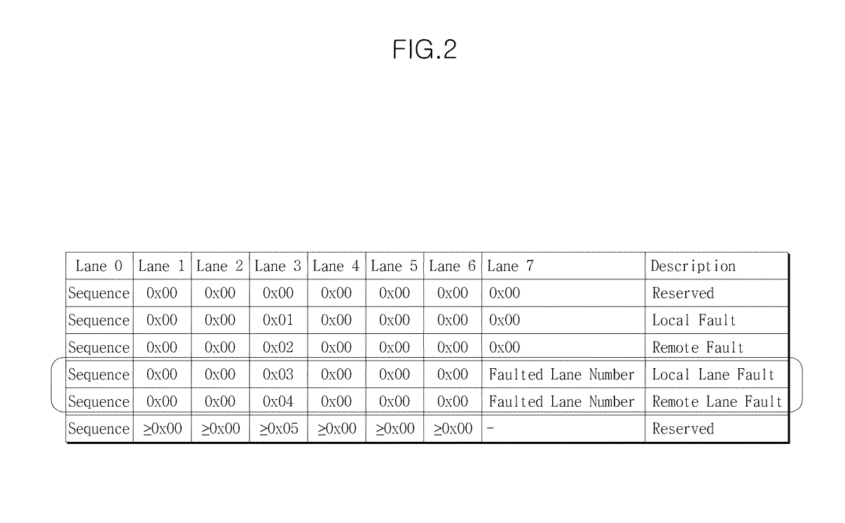

FIG. 2 illustrates a lane fault message according to an exemplary embodiment of the present invention.

In the present exemplary embodiment, the lane fault message includes information indicating whether a single lane is faulty and identifier information of the faulty lane. Values of Lane 0, Lane 1, and Lane 2 among unused field values in standardized Ethernet are the same as those of a LF message. A value indicating that a local lane fault is generated is set in Lane 3 to indicate that a local lane is faulty, or a value indicating that a remote lane fault is generated may be set to indicate that a remote lane is faulty. In the present exemplary embodiment, the value indicating that a local lane fault is generated is 3 and the value indicating that a remote lane fault is generated is 4.

The faulty lane information may be delivered via some of Lanes 4 to 7. In FIG. 2, a lane number is recorded using Lane 7.

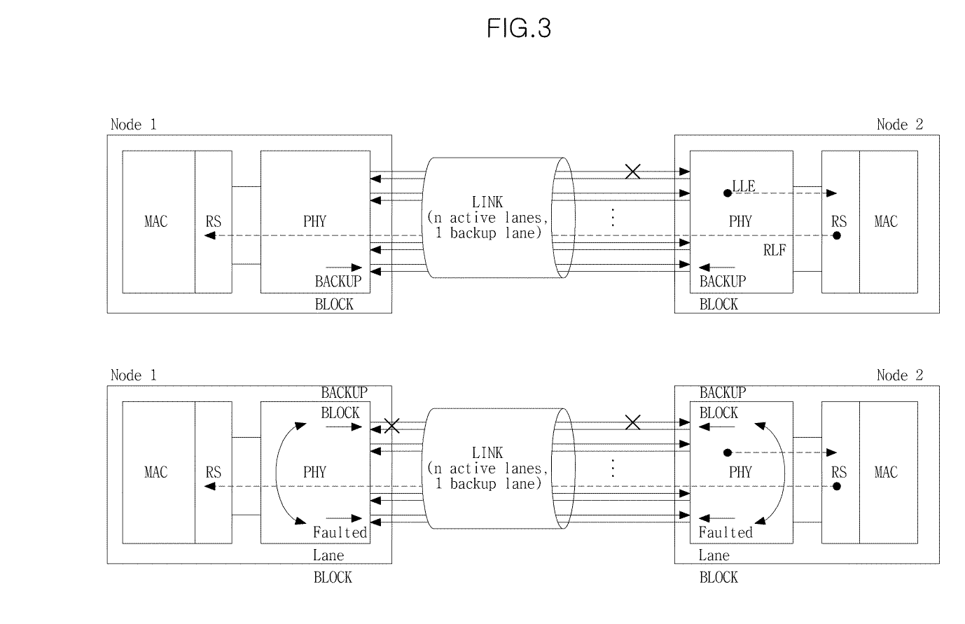

FIG. 3 illustrates an Ethernet lane fault recovery system according to an exemplary embodiment of the present invention.

A process of recovering a single lane fault at a normal state of operation between node 1 and node 2 in the Ethernet lane fault recovery system in a normal linear network in FIG. 3 is shown.

As shown in FIG. 3, when a single faulty lane is detected, a receiving stage transmits an LLF message to its RS layer. The RS layer determines whether to process the fault as a link fault or as lane fault.

When the fault is determined to be a lane fault, the receiving stage transmits an RLF message to a correspondent apparatus (i.e., a transmitting stage) for fault recovery. After the transmitting stage receives the RLF message, an RS layer at the transmitting stage delivers a control signal for lane switching to a PMD sublayer. In response to a control signal, fault recovery is accomplished by using the backup lane to transfer a data block intended to be transferred via the faulty lane. The faulty lane is set to transfer a meaningless backup block. An Ethernet link can maintain a normal connection state due to the lane fault recovery function of substituting the fault lane with the backup lane.

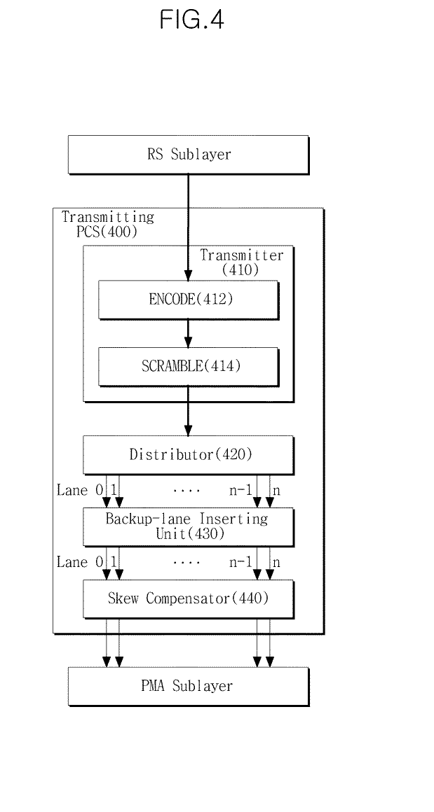

FIG. 4 is a block diagram illustrating the transmitting Ethernet apparatus according to an exemplary embodiment of the present invention.

Referring to FIG. 4, a PCS sublayer of the transmitting Ethernet apparatus according to an exemplary embodiment of the present invention includes a transmitter 410, a distributor 420, a backup-lane inserting unit 430, and a skew compensator 440.

The transmitter 410 encodes (412) and scrambles (414) data received from the RS sublayer.

The distributor 420 distributes the data received via the transmitter 410 into n data blocks to distribute normal data into a plurality of lanes.

For lane fault recovery, the backup-lane inserting unit 430 adds a backup lane for the data, which has been distributed for transfer via a total of n lanes by the distributor 420. That is, the data is transferred via a total of n+1 transfer lanes by the backup-lane inserting unit 430.

The skew compensator 440 inserts an alignment block for data skew compensation at a receiving side. Data with the alignment block inserted by the skew compensator 440 is transferred via a total of n+1 transfer lanes to a PMA sublayer and then the same data transmission process may be performed on all of the lanes.

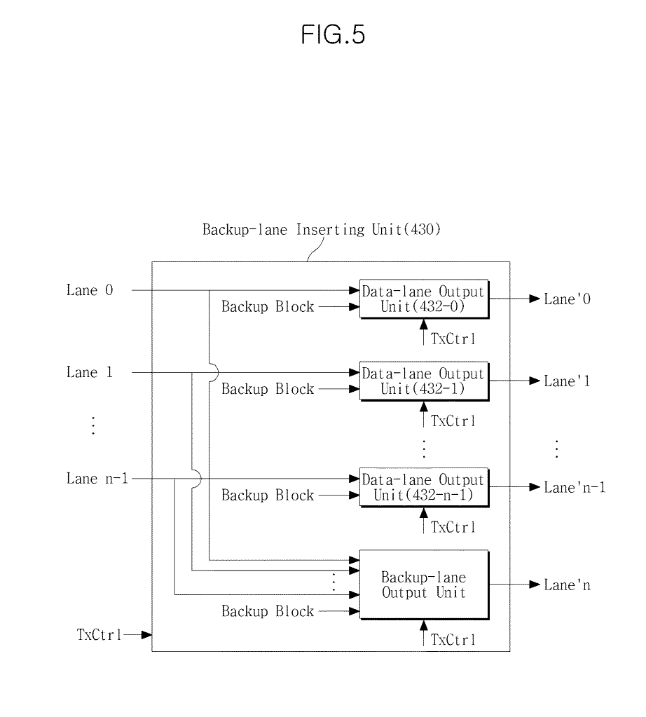

FIG. 5 is a block diagram illustrating a backup-lane inserting unit according to an exemplary embodiment of the present invention.

As shown in FIG. 5, the backup-lane inserting unit 430 receives data from the distributor 420 via the n lanes and receives a control signal TxCtrl for lane switching.

In response to the control signal TxCtrl for lane switching, data-lane output units 432-0, 432-1, . . . , 432-n−1 for the respective lanes may determine whether to transmit the data via the lanes having their lane number or via the backup lane.

That is, the control signal TxCtrl indicates that a lane having a lane number x (x is between 0 and n−1) is faulty, the data-lane output unit 432-x for the lane x selects a backup block rather than the input data and outputs the backup block via the lane number x. On the other hand, a backup-lane output unit 434 for determining data to transmit via the backup lane selects and outputs the data on the faulty lane x via the backup lane in response to the control signal TxCtrl.

When no lanes are faulty, the backup-lane output unit 434 outputs the backup block via the backup lane in response to the control signal TxCtrl.

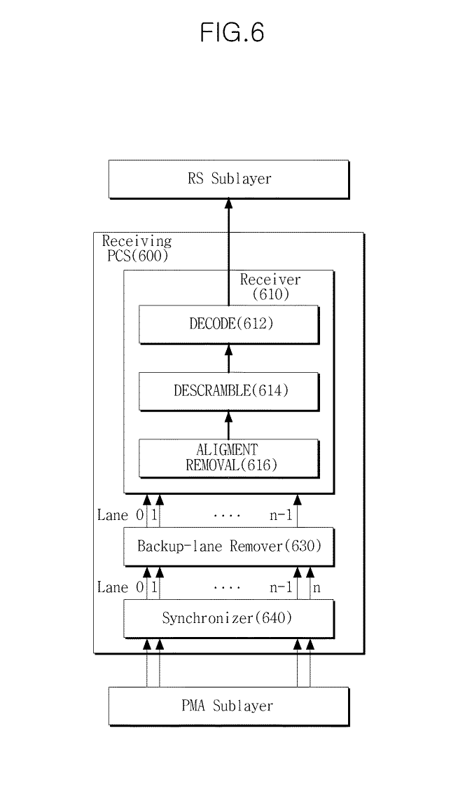

FIG. 6 is a block diagram illustrating a receiving Ethernet apparatus according to an exemplary embodiment of the present invention.

Referring to FIG. 6, a PCS sublayer of the receiving Ethernet apparatus according to an exemplary embodiment of the present invention includes a synchronizer 640, a backup-lane remover 630, and a receiver 610.

In the present exemplary embodiment, the receiving Ethernet apparatus receives data via n normal data lanes and one backup lane.

The synchronizer 640 performs synchronization and skew compensation on the n+1 lanes via the PMA sublayer.

The backup-lane remover 630 removes the backup lane from a total of n+1 lanes and outputs data through the n lanes. In the present exemplary embodiment, in a normal state where all lanes are faultless, the backup-lane remover 630 removes a backup block transferred via the backup lane. On the other hand, when there is a faulty lane, the backup-lane remover 630 returns the data transferred via the backup lane as an output of the faulty lane.

The receiver 610 removes the alignment block inserted for skew compensation from the data received via a total of the n data lanes excluding the backup lane removed by the backup-lane remover 630 (616). The receiver 610 performs descrambling and decoding processes 614 and 612 on the data and delivers the resultant data to the RS sublayer.

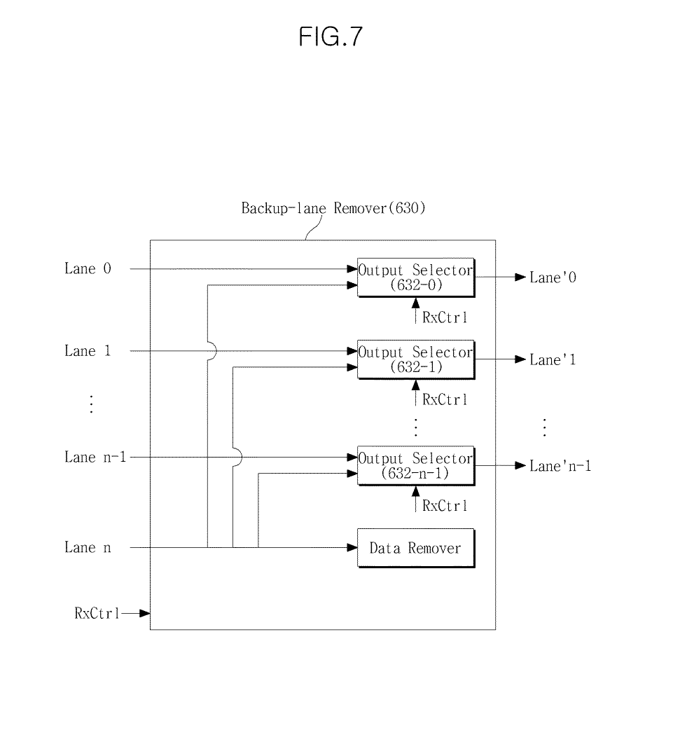

FIG. 7 is a block diagram illustrating the backup-lane remover according to an exemplary embodiment of the present invention.

In the present exemplary embodiment, the backup-lane remover 630 removes the backup lane from the n+1 lanes and outputs data via the n lanes. Each of the output selectors 632-0, 632-1, . . . 632-n−1 for the lanes selects data received via the corresponding lane or the backup lane n according to whether the lane is faulty, and outputs the selected data.

In a normal state where all of the lanes are faultless, the data remover 634 removes the backup block transferred via the backup lane and outputs data received via the other data lanes, via the same lanes.

On the other hand, when any specific lane x (x is between 0 and n−1) is faulty, the output selector 632-x for the lane x outputs the data received via the backup lane n rather than the backup block received via the lane x, in response to the control signal RxCtrl.

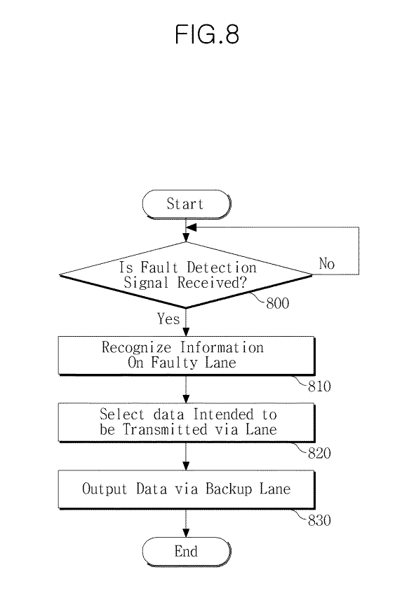

FIG. 8 is a flowchart illustrating a method for transmitting data according to an exemplary embodiment of the present invention.

First, a determination may be made as to whether any lane is faulty based on a fault detection signal received from a correspondent Ethernet apparatus (operation 800). Information on the faulty lane is recognized from the fault detection signal (operation 810).

Data intended to be transmitted via the faulty lane is selected as a backup block (operation 820) and is output via the backup lane (operation 830).

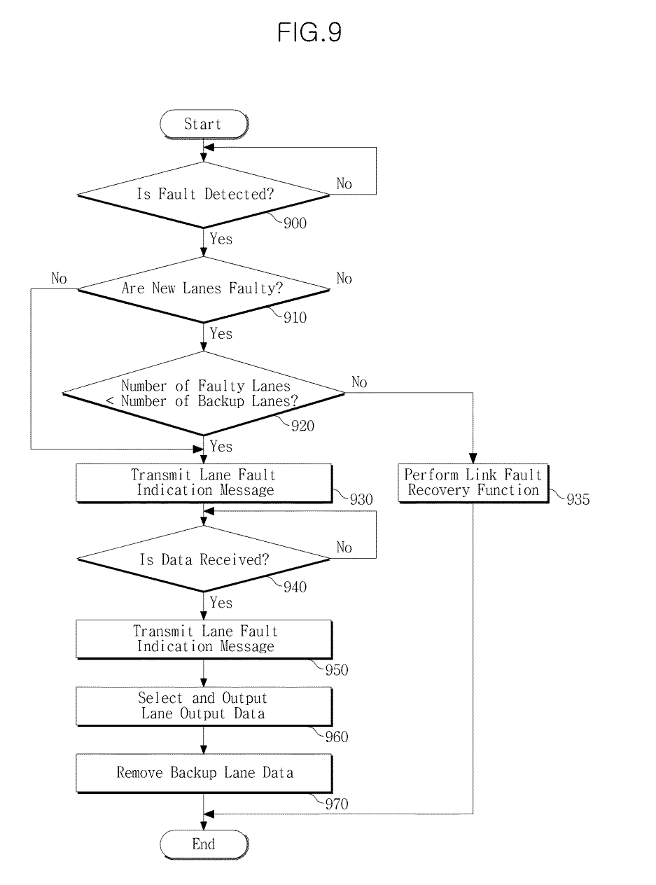

FIG. 9 is a flowchart illustrating a method for receiving data according to an exemplary embodiment of the present invention.

First, when faulty lanes are detected (operation 900), a determination is made as to whether new lanes are faulty (operation 910). When the number of lanes to be recovered is less than or equal to the number of previously set backup lanes, a lane fault indication message is transmitted to a correspondent Ethernet apparatus (operation 930). The lane fault indication message includes information indicating the faulty lanes. On the other hand, when the number of lanes to be recovered is greater than the number of the previously set backup lanes, a determination is made that the fault is to be processed as a whole-link fault (operation 935). In this case, a link fault recovery function may be performed by standardized Ethernet technology.

When data is received via a plurality of data transfer lanes and a backup lane from the correspondent Ethernet apparatus (operation 940), according to whether a lane is faulty, data received via the transfer lanes or via the backup lane is selected according to whether the lanes are faulty and output (operation 950). That is, the data transmitted via the backup lane may be recognized as data transmitted via the faulty one of the plurality of data transfer lanes.

The data received via the backup lane is then removed (operation 960). Accordingly, data may be ultimately output to an upper layer according to the number of the data lanes.

Meanwhile, the methods for transmitting and receiving data may be written as a computer program-readable code. The program is stored in a computer-readable recording medium, and may be implemented as it is read and executed by a computer. The recording medium includes a magnetic recording medium, an optical recording medium, etc.

The present invention can be implemented as computer readable codes in a computer readable record medium. The computer readable record medium includes all types of record media in which computer readable data are stored. Examples of the computer readable record medium include a ROM, a RAM, a CD-ROM, a magnetic tape, a floppy disk, and an optical data storage. Further, the record medium may be implemented in the form of a carrier wave such as Internet transmission. In addition, the computer readable record medium may be distributed to computer systems over a network, in which computer readable codes may be stored and executed in a distributed manner.

As apparent from the above description, an Ethernet apparatus having a multi-lane structure can accurately recognize fault generation and faulty lanes while maintaining compatibility with a standard Ethernet apparatus.

When limited lanes are faulty, an implementation and control process can be simplified and a link status can be recovered rapidly by providing a fault recovery function within an Ethernet physical layer without using a protection switching method at a system or network level, thereby increasing reliability.

In addition, data transferred via faultless lanes cannot be affected because only faulty lanes are controlled for protection switching.

It will be apparent to those of ordinary skill in the art that various modifications can be made to the exemplary embodiments of the invention described above. However, as long as modifications fall within the scope of the appended claims and their equivalents, they should not be misconstrued as a departure from the scope of the invention itself.

What is claimed is:

1. An Ethernet apparatus capable of lane fault recovery in which data is transmitted and received via a transport link including a plurality of data transfer lanes, the apparatus comprising:
a data transmitter using a backup lane in the transport link to transmit, data intended to be transmitted via the faulty lane when at least one faulty lane is detected from the data transfer lanes; and
a data receiver recognizing the data received via the backup lane as data transferred via the faulty lane when the faulty lane is detected.

2. The apparatus of claim 1, wherein the data transmitter comprises a backup-lane inserting unit, the backup-lane inserting unit comprising a data-lane output unit selecting data received via the plurality of transfer lanes or a backup block in response to a fault detection signal and outputting the selected data or backup block, and a backup-lane output unit selecting the backup block or the data intended to be transferred via the detected faulty lane in response to the fault detection signal and outputting the selected backup block or data via the backup lane.

3. The apparatus of claim 1, wherein the data receiver comprises a backup-lane remover selecting data received via one of the plurality of transfer lanes or via the backup lane according to whether the lane is faulty, outputting the selected data, and removing the data received via the backup lane.

4. The apparatus of claim 1, wherein the Ethernet apparatus detects a lane fault upon receiving data and transmits a lane fault indication message to a correspondent Ethernet apparatus.

5. The apparatus of claim 4, wherein the lane fault indication message includes lane identification information.

6. The apparatus of claim 4, wherein when a lane fault is detected, the Ethernet apparatus compares the number of faulty lanes with the number of previously set backup lanes, and transmits the lane fault indication message when the number of faulty lanes is less than or equal to the number of previously set backup lanes.

7. The apparatus of claim 4, wherein when a lane fault is detected, the Ethernet apparatus compares the number of faulty lanes with the number of previously set backup lanes, and transmits a link fault indication message when the number of faulty lanes is greater than the number of previously set backup lanes.

8. The apparatus of claim 1, wherein the data transmitter is implemented on a physical coding sublayer (PCS) of a physical layer.

9. The apparatus of claim 1, wherein the data receiver is implemented on a PCS of a physical layer.

10. A method for transmitting data via a transport link comprising a plurality of data transfer lanes, the method comprising:
detecting at least one faulty one from the data transfer lanes; and
transferring data intended to be transmitted via the faulty lane using a backup lane in the transport link.

11. The method of claim 10, wherein the transferring of the data comprises:
selecting data received via one of the plurality of transfer lanes or a backup block in response to a fault detection signal and outputting the selected data or backup block; and
selecting the backup block or the data intended to be transferred via the detected faulty lane in response to the fault detection signal and outputting the selected backup block or data via the backup lane.

12. The method of claim 10, wherein the detecting of the at least one faulty one from the data transfer lanes comprises:
receiving a fault detection signal from a correspondent Ethernet apparatus; and
recognizing a lane fault and information on faulty lanes from the fault detection signal.

13. A method for receiving data via a transport link comprising a plurality of data transfer lanes, the method comprising:
receiving data via the plurality of data transfer lanes and backup lanes; and
recognizing the data received via the backup lane as data transferred via a faulty lane of the plurality of data transfer lanes when the faulty lane is detected.

14. The method of claim 13, wherein the recognizing of the data comprises:
selecting data received via one of the plurality of transfer lanes or via the backup lane according to whether the lane is faulty and outputting the selected data; and
removing the data received via the backup lane.

15. The method of claim 13, further comprising:
detecting a lane fault; and
transmitting a lane fault indication message to a correspondent Ethernet apparatus according to a result of detecting the lane fault.

16. The method of claim 15, wherein the lane fault indication message comprises identification information for a faulty lane.

17. The method of claim 15, wherein the transmitting of the lane fault indication message comprises comparing the number of faulty lanes with the number of previously set backup lanes and transmitting the lane fault indication message when the number of faulty lanes is less than or equal to the number of previously set backup lanes.

18. The method of claim 15, wherein the transmitting of the lane fault indication message comprises comparing the number of faulty lanes with the number of previously set backup lanes and performing a link fault recovery function when the number of the faulty lanes is greater than the number of previously set backup lanes.
